(19) United States
(12) Patent Application Publication
(10) Pub. No.: US 2026/0175287 A1
(43) Pub. Date: Jun. 25, 2026

(54) MICROFORGE SYSTEM AND METHOD

(71) Applicant: THE BOEING COMPANY, Arlington, VA (US)

(72) Inventors: Christopher R. Heckman, St. Louis, MO (US); David P. Heck, St. Louis, MO (US); Andrew H. Baker, St. Louis, MO (US)

(73) Assignee: THE BOEING COMPANY, Arlington, VA (US)

(21) Appl. No.: 18/989,310

(22) Filed: Dec. 20, 2024

(51) Int. Cl. B21J 5/00; B22F 10/20; B22F 12/60; B33Y 10/00; B33Y 30/00

(52) U.S. Cl. CPC B21J 5/008; B22F 10/20; B22F 12/60; B33Y 10/00; B33Y 30/00; B22F 2201/10

(57) ABSTRACT

A microforge system for additive metallic manufacturing includes a forge barrel with a forge head configured to move in opposite directions within the forge barrel. A metal supply device supplies metal powder into the forge barrel, and one or more inductive heaters inductively heat the metal powder within the forge barrel. The forge head oscillates within the forge barrel while the metal powder is heated and sintered onto a substrate to form a solid metal additive layer. The system may include an inert gas supply device to load inert gas into the forge barrel, allowing the metal powder to be heated and forged without a vacuum chamber. The forge head compacts the metal powder to produce a solid metal additive layer with a wrought microstructure. A translation system moves the forge barrel and inductive heaters transversely relative to the forge head's oscillation.

### FIELD OF THE DISCLOSURE

The present relates to advanced manufacturing technologies, specifically to thermal-mechanical metal powder feeding systems and methods for additive metallic manufacturing.

### BACKGROUND OF THE DISCLOSURE

Advanced manufacturing technologies encompass a wide range of processes and systems designed to improve the efficiency, precision, and capabilities of manufacturing operations. These technologies often use computer-controlled machinery, robotics, and advanced materials to produce complex parts and components with high accuracy. Applications of advanced manufacturing technologies include aerospace, automotive, medical devices, and consumer electronics, where precision and performance are critical.

In the field of metallic additive manufacturing, complex metallic parts are capable of being created by adding material layer-by-layer. This allows the system to produce intricate geometries that are difficult or impossible to achieve with traditional subtractive manufacturing methods. Metallic additive manufacturing is capable of being in various industries, including aerospace, automotive, and medical, to produce parts with high strength, lightweight properties, and customized designs.

Achieving rapid manufacturing of complex metallic parts presents several challenges. Some known methods require large vacuum or inert gas chambers, which are costly to maintain and restrict the size of the parts that are produced. These methods also may rely on liquid melt pools, which complicate the final microstructure, heat treatability, and performance of the parts.

There is thus a need for a system and method that addresses the limitations of existing metallic additive manufacturing techniques, enabling the rapid production of complex metallic parts without the need for large vacuum or inert gas chambers or liquid melt pools.

### SUMMARY OF THE DISCLOSURE

According to one aspect of the subject matter described herein, a microforge system comprises a forge barrel including a forge head configured to move in opposite directions within the forge barrel, a metal supply device fluidly coupled with the forge barrel and configured to supply metal powder into the forge barrel, and one or more inductive heaters configured to inductively heat the metal powder within the forge barrel. The forge head is configured to oscillate in the opposite directions within the forge barrel while the metal powder is heated and sintered by the forge head onto a substrate to form a solid metal additive layer on the substrate.

According to another aspect, the microforge system further comprises an inert gas supply device fluidly coupled with the forge barrel and configured to load inert gas into the forge barrel.

According to yet another aspect, the inert gas supply device is configured to load the inert gas into the forge barrel for the metal powder to be heated and forged without a vacuum chamber.

According to another aspect, the forge head is configured to compact the metal powder while heated by the one or more inductive heaters to produce the solid metal additive layer with a wrought microstructure on the substrate.

According to yet another aspect, the microforge system further comprises a translation system coupled with the forge barrel and the one or more inductive heaters. The translation system is configured to move the forge barrel and the one or more inductive heaters in one or more movement directions transversely oriented relative to the opposite directions in which the forge head oscillates.

According to another aspect, the microforge system further comprises a force applicator configured to apply a downward force onto the solid metal additive layer and change a grain structure of the solid metal additive layer.

According to yet another aspect, the force applicator includes an isostatic bearing roller configured to roll on top of the solid metal additive layer to apply the downward force.

According to another aspect, a method comprises supplying metal powder into a forge barrel of a microforge system, inductively heating the metal powder within the forge barrel, and oscillating a forge head in opposite directions within the forge barrel while the metal powder is heated to sinter the forge head onto a substrate and form a solid metal additive layer on the substrate.

According to yet another aspect, the method further comprises loading inert gas into the forge barrel ahead of the metal powder.

According to another aspect, oscillating the forge head and inductively heating the metal powder compacts the metal powder to produce the solid metal additive layer with a wrought microstructure on the substrate.

According to yet another aspect, the method further comprises moving the forge barrel in one or more movement directions transversely oriented relative to the opposite directions in which the forge head oscillates while the solid metal additive layer is formed on the substrate.

According to another aspect, the method further comprises changing a grain structure of the solid metal additive layer by applying a downward force onto the solid metal additive layer.

According to yet another aspect, the downward force is applied by rolling an isostatic bearing roller on top of the solid metal additive layer.

According to another aspect, a microforge system comprises a forge barrel including a forge head configured to move in opposite directions within the forge barrel, a metal supply device fluidly coupled with the forge barrel and configured to supply metal into the forge barrel, and one or more inductive heaters configured to inductively heat the metal within the forge barrel. The forge head is configured to oscillate in the opposite directions within the forge barrel to heat and sinter the metal onto a substrate to form a solid metal additive layer on the substrate while the forge barrel and the one or more inductive heaters move relative to the substrate.

According to yet another aspect, the microforge system further comprises an inert gas supply device fluidly coupled with the forge barrel and configured to load inert gas into the forge barrel ahead of the metal.

According to another aspect, the inert gas supply device is configured to load the inert gas into the forge barrel for the metal to be heated and forged without a vacuum chamber.

According to yet another aspect, the forge head is configured to compact the metal while heated by the one or more inductive heaters to produce the solid metal additive layer with a wrought microstructure on the substrate.

According to another aspect, the microforge system further comprises a translation system coupled with the forge barrel and the one or more inductive heaters. The translation system is configured to move the forge barrel and the one or more inductive heaters in one or more movement directions transversely oriented relative to the opposite directions in which the forge head oscillates.

According to yet another aspect, the microforge system further comprises a force applicator configured to apply a downward force onto the solid metal additive layer and change a grain structure of the solid metal additive layer.

According to another aspect, the force applicator includes an isostatic bearing roller configured to roll on top of the solid metal additive layer to apply the downward force.

### BRIEF DESCRIPTION OF THE DRAWINGS

FIG. 1 shows a schematic diagram of one example of the microforge system for thermal-mechanical powder feeding and metallic additive manufacturing.

FIG. 2 illustrates a flow chart diagram depicting one example of the method for forming a solid metal additive layer using a microforge system.

FIG. 3 illustrates another example of the microforge system.

FIG. 4 illustrates a cross-sectional view of the microforge system shown in FIG. 3.

FIG. 5 illustrates another example of the microforge system.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition are capable of including additional elements not having that condition.

Manufacturing complex metallic parts rapidly present significant challenges. Traditional methods often require large vacuum or inert gas chambers, which are costly to maintain and restrict the size of the parts that are produced. These methods also rely on liquid melt pools, which complicate the final microstructure, heat treatability, and performance of the parts. Additionally, current techniques are typically limited to laying down a single material type or alloy system at a time, and those that handle multiple materials often require the use of wire feedstock, which is not feasible for all alloys due to brittleness.

Existing manufacturing methodologies face several drawbacks. The reliance on large vacuum or inert gas chambers increases operational costs and limits the size and scope of the parts that are capable of being produced. The use of liquid melt pools complicates the final microstructure, heat treatability, and performance of the parts. Additionally, these techniques are dependent on heat mass, which significantly slows down the production process. The need for complex scaffolding structures to support the print further complicates the process, adding to the time and cost of production.

The microforge system and method described herein addresses these challenges by providing a thermal-mechanical powder feeder and printing head that eliminates the need for large vacuum or inert gas chambers. The system utilizes locally loaded puffs or spurts of inert gas without a vacuum chamber, allowing the inert gas and powder to travel down together. The forge needle, traveling along the barrel, is designed to be heated rapidly via induction as the powder travels down the barrel and is capable of being rapidly cooled when being forged or mechanically introduced to the manufacturing substrate. The needle optionally is referred to as a hammer or piston. This approach enables the rapid laydown and formation of a part bond material without necessitating a melt pool, combining both mechanical and localized sintering to achieve a wrought microstructure.

By supplying metal powder into the forge barrel and inductively heating the metal powder within the barrel, the system and method ensure that the metal powder reaches the necessary temperature for sintering without requiring a melt pool. This approach allows for precise control over the heating process, ensuring uniform temperature distribution and reducing the risk of defects in the final product.

The oscillation of the forge head in opposite directions within the forge barrel while the metal powder is heated facilitates the mechanical compaction and sintering of the powder onto the substrate. This dual-action process combines thermal and mechanical energy to create a solid metal additive layer with a wrought microstructure, which is typically stronger and more durable than a cast microstructure.

Additionally, the method eliminates the need for large vacuum or inert gas chambers, making the system more cost-effective and versatile. The localized heating and sintering process allows for rapid manufacturing of complex metallic parts, improving production speed and efficiency compared to traditional methods.

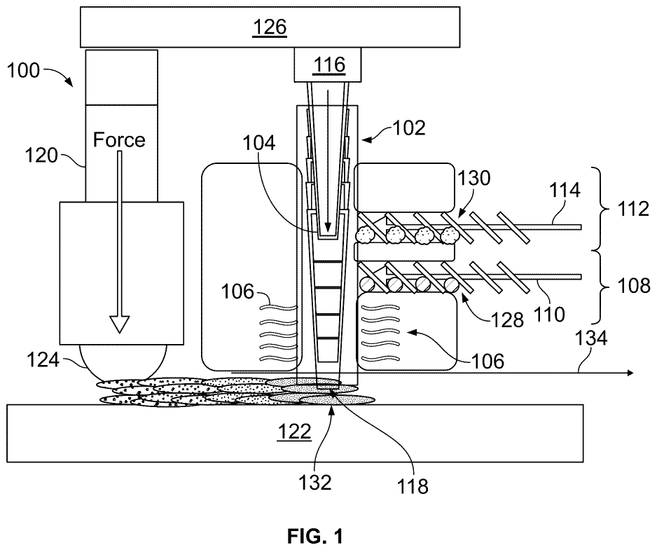

FIG. 1 shows one example of a microforge system 100. The microforge system 100 is capable of being used for thermal-mechanical powder feeding and metallic additive manufacturing. The system 100 includes a forge barrel 102, which serves as a primary conduit for a metal powder and inert gas mixture to be delivered toward a substrate or build platform. The barrel 102 can be an elongated, cylindrical (or substantially cylindrical), or rectangular component of the microforge system 100 that serves as the primary conduit for the metal powder and inert gas mixture. The barrel 102 guides these materials from the supply devices to a forge head or forge needle 104, ensuring controlled and precise delivery. The barrel 102 is capable of withstanding the mechanical forces and high temperatures involved in the thermal-mechanical powder feeding and sintering process. The barrel may be constructed from materials such as high-strength steel, or other metals, or ceramic to enhance durability and energy efficiency.

The forge head or forge needle 104 operates within the forge barrel 102 and is responsible for applying mechanical force to the metal powder material. The forge head or forge needle 104 rapidly moves up and down in opposite directions, similar to a sewing machine needle, to compact the metal powder material onto the substrate 122. The substrate of previously laid down metal 122 (or other material) functions to serve as the base layer for the new material 132. The substrate 122 (or build surface) is designed to provide a stable foundation for the additive manufacturing process described herein.

The forge head or forge needle 104 is capable of being inductively heated by the inductive heaters 106, which are positioned along or around the forge barrel 102. The inductive heaters 106 provide rapid and localized heating to the powder material as the powder material travels down the barrel, facilitating the sintering process without the need for a melt pool.

The metal supply device 108 and the metal supply screw 110 work in tandem to deliver a precise amount of powdered metal into the forge barrel 102. The metal supply device 108 stores the powdered metal, while the metal supply screw 110 meters the powder into the barrel in controlled quantities. This helps ensure that the correct amount of powder is available for each forging cycle, maintaining consistency in the material laydown process.

The metal 128 and inert gas 130 are capable of being the primary materials used in the manufacturing process, with the metal 128 being powdered feedstock and the inert gas 130 providing the protective atmosphere. The recently laid down metal 132 represents the newly formed layer of material, which is compacted and sintered onto the substrate 122. The movement direction 134 indicates the path along which the microforge system 100 travels during the additive manufacturing process.

The inert gas supply device 112 and the inert gas screw 114 are responsible for introducing puffs or spurts of inert gas into the forge barrel 102. The inert gas supply device 112 functions to store the inert gas, and the inert gas screw 114 releases measured amounts of gas into the barrel. Optionally, the inert gas screw 114 is capable of being a flow control valve or system of valves that control the rate and/or amount of the inert gas that is delivered into the barrel. The inert gas surrounds the powder particles, preventing oxidation and ensuring a clean sintering process during laydown of the metal material. The inert gas and powder travel down the forge barrel 102 together, with the inert gas acting as a protective atmosphere around the powder.

The inert gas is capable of being a gas that does not undergo chemical reactions under a set of given conditions. In the context of the microforge system, inert gas is capable of being used to create a protective atmosphere around the metal powder particles during the sintering process. The inert gas prevents oxidation and other unwanted chemical reactions that could compromise the quality and integrity of the metal additive layer. Examples of inert gases include argon, nitrogen, and helium.

The forge head or forge needle actuator 116 controls the movement of the forge head or forge needle 104. The actuator 116 ensures precise and rapid motion, allowing the forge head or forge needle 104 to apply the necessary mechanical force to the powder material. The actuator 116 represents one or more motors, pneumatic actuators, or the like, which oscillate the head or needle 104 in opposite directions (e.g., toward and away from the build surface). The forge barrel outlet 118 is the exit point for the compacted and sintered metal material, and directs this material onto the build surface (e.g., a substrate of previously laid down metal 122 or another material).

Optionally, a force applicator device 120 provides additional mechanical force to the forge head or forge needle 104. This improves compaction in the sintering process. The force applicator device 120 improves the properties of the additively manufactured metal material 132 that is laid down by the microforge system 100. By applying additional mechanical force to the laid down material 132, the force applicator device 120 is capable of changing the grain structure of this material. This grain refinement process involves the deformation and recrystallization of the metal grains in the laid down material 132, which is designed to result in a finer and more uniform grain structure of this material 132.

When the force applicator device 120 applies a downward force onto the solid metal additive layer 132, the device 120 functions to induce plastic deformation in the material 132. This deformation is designed to cause the metal grains in the laid down material layer 132 to elongate and align in the direction of the applied force (“Force” in FIG. 1). As the material 132 cools and recrystallizes, new, smaller grains are capable of forming and replacing elongated grains in the material 132. This refined grain structure functions to improve the mechanical properties of the metal material 132, such as the strength, hardness, and ductility of the metal material 132.

The force applicator device 120 optionally includes an isostatic bearing roller 124. This roller 124 is designed to roll along the laid down metal material 132 and follow the forge head or forge needle 104. The roller 124 is capable of applying uniform or substantially uniform pressure to the recently laid down metal 132. This uniform pressure is designed to help to eliminate voids in the laid down metal 132 and improve layer uniformity, which also is designed to improve the mechanical properties of the material 132. The combination of mechanical compaction and grain refinement is designed to result in a wrought microstructure in the laid down material 132, which is typically stronger and more durable than a cast microstructure. In one example, the roller 124 is capable of being cooled (e.g., using a heat sink) to promote faster directional cooling of the laid down material 132. Alternatively, the isostatic bearing roller 124 may not be included and/or used.

By changing the grain structure of the laid down metal material 132, the force applicator device 120 is designed to improve the overall quality and performance of the additively manufactured parts formed by the laid down material 132 and/or substrate 122 (which may be formed from one or more layers of previously laid down material 132). This improvement is designed to be beneficial for applications in industries such as aerospace, automotive, and medical devices, where high strength and reliability may be more important than in other applications.

The isostatic bearing roller 124 optionally follows the forge head or forge needle 104, applying uniform pressure to the recently laid down metal 132 to ensure layer uniformity and eliminate voids. The translation system 126 is capable of moving the entire microforge system 100 along a desired path, allowing for precise control over the material laydown process. The translation system 126 is designed to move in multiple directions, enabling the system to lay down material at various angles and orientations.

The translation system 126 in the microforge system 100 is capable of providing precise control over the material laydown process by moving the microforge system in multiple directions that are transverse or orthogonal to the build surface 122. This capability allows the system 100 to deposit additional material 132 on various surfaces, including those below the system 100, vertical surfaces, and even surfaces above the microforge system 100 (with the microforge system 100 oriented upside-down). This allows for additive manufacturing in a wide range of orientations.

The translation system 126 includes one or more gantries, motors, pulleys, etc. that enable movement in multiple directions. These gantries are capable of rastering the microforge system across the build surface, ensuring uniform and consistent deposition of the additional material 132. The translation system 126 is designed to move the system along the X, Y, and Z axes, allowing for precise control over the position and orientation of the forge head or forge needle 104 during the additive manufacturing process.

By enabling movement in multiple directions, the translation system 126 allows the microforge system 100 to print on surfaces above the system 100. This capability is particularly useful for creating complex geometries and structures that require material deposition on the underside of components. The system 100 also is designed to print on vertical surfaces, which is beneficial for manufacturing parts with vertical walls or features that extend upward from the build surface 122.

Optionally, the microforge system is capable to operate with a forge barrel made from high-strength steel or other metals, or ceramics to withstand the mechanical forces and high temperatures involved in the process. The forge head, which oscillates within the forge barrel, is capable of operating with a tungsten tip to enhance durability and precision during the sintering process. In one example, the tip may be formed from pure tungsten, or tungsten that is not intentionally mixed with any other metals or other materials. The metal supply device is designed to include a hopper and a screw feeder mechanism to ensure a consistent and controlled flow of metal powder into the forge barrel. The inductive heaters are capable of being arranged in a helical pattern around the forge barrel to provide uniform heating of the metal powder. In another embodiment, the forge barrel is capable of being made from a ceramic material to reduce thermal conductivity and improve energy efficiency. The forge head is capable of being equipped with a replaceable tip to allow for easy maintenance and adaptation to different types of metal powders. The metal supply device is capable of utilizing a vibratory feeder to handle metal powders with varying particle sizes. The inductive heaters are capable of being integrated with temperature sensors to provide real-time feedback and precise control over the heating process. Additionally, the system is capable of including a cooling mechanism, such as a water-cooled jacket around the forge barrel, to manage the thermal load and prevent overheating. Optionally, the microforge system is capable of including multiple forge heads operating in parallel within a single forge barrel to increase production speed and efficiency. The metal supply device can be designed to include multiple hoppers, each containing a different type of metal powder, to enable the creation of multi-material parts. The inductive heaters function to be segmented and independently controlled to allow for differential heating along the length of the forge barrel or the powder supply system, thereby optimizing the sintering process for complex geometries. The system is capable of incorporating an inert gas recirculation system to minimize gas consumption and reduce operational costs.

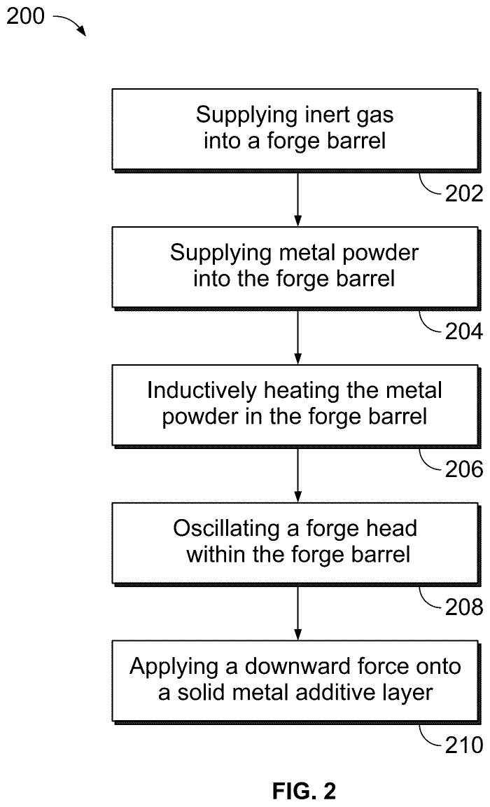

FIG. 2 illustrates a flowchart of one example of a method 200 for additively manufacturing metal layers using a microforge system. The method 200 includes several steps or operations to achieve the formation of solid metal additive layers and can represent the operations performed by the microforge system 100.

At 202, inert gas is supplied into a forge barrel. The inert gas supply device is designed to introduce puffs or spurts of inert gas into the forge barrel to create a protective atmosphere around metal powder particles. This prevents oxidation of the metal powder during the subsequent heating and sintering processes.

At 204, metal powder is supplied into the forge barrel 204. The metal supply device, which is capable of including a metal supply screw, delivers precise amounts of powdered metal into the forge barrel. This helps provide a controlled and consistent flow of metal powder for each forging cycle.

At 206, the metal powder and forge head or needed is inductively heated in the forge barrel 206. Inductive heaters positioned along or around the forge barrel are designed to provide rapid and localized heating to the metal powder as the metal powder travels down the barrel. This heating process helps sinter the metal powder without the need for a melt pool.

At 208, the forge head or needle oscillates within the forge barrel. The forge head or forge needle is capable of rapidly moving in opposite directions in the forge barrel. In one example, the tip or end of the forge head or needle remains in the forge barrel during operation of the system 100 without the head or needle extending out of the outlet of the barrel. For example, the tip or end of the forge head or needle is designed to extend to the outlet but not beyond this outlet. Alternatively, the tip or head projects out of the outlet of the barrel during oscillations. The mechanical motion of the head or needle compacts the heated metal powder onto the substrate to aid the sintering process and form a solid metal additive layer.

At 210, a downward force optionally is applied onto the solid metal additive layer laid down by the microforge system. A force applicator, such as an isostatic bearing roller, is designed to follow the forge head and applies uniform pressure to the recently laid down metal. This additional mechanical force increases compaction and sintering of the recently laid down layer to increase layer uniformity and reduce voids in the solid metal additive layer 132.

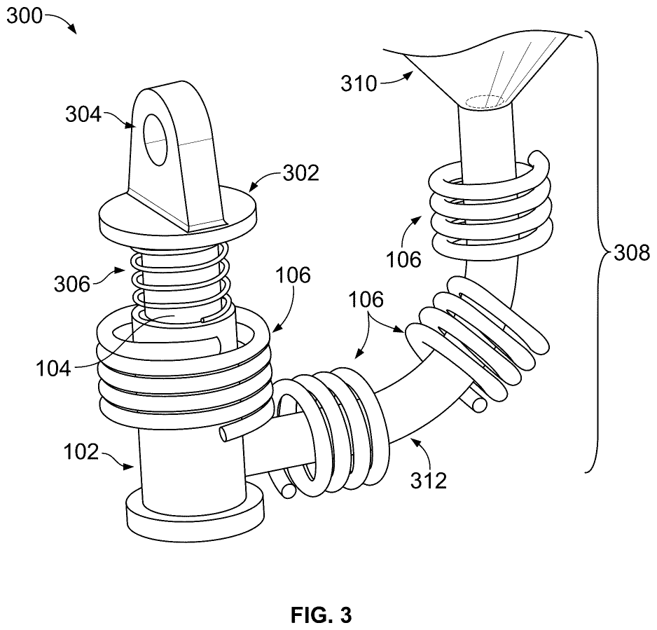

FIG. 3 illustrates another example of a microforge system 300. The microforge system 300 may represent another version of the microforge system 100 shown in FIG. 1. The microforge system 300 is designed to include a hammer or piston 302 that connects to the actuator 116 and to the forge head or needle 104. For example, this hammer or piston 302 can be a body coupled with one end the needle 104 and is designed to include an opening for attaching to the actuator 116 for transferring movement of the actuator 116 to movement of the needle 104. A biasing element 306 (e.g., a spring) is disposed between the hammer or piston 302 and the barrel 102. As the actuator 116 pushes the hammer or piston 302 and the needle 104 down toward the build surface, the biasing element 304 becomes compressed or biased. As the actuator 116 releases or moves away from the barrel 102, the biasing element 304 may expand and push the hammer or piston 302 (and the needle 104) away from the build surface.

In contrast to the microforge system 100, the microforge system 300 may include a feed system 308 that delivers both the inert gas and metal powder to inside the barrel 102. This feed system 308 is designed to include a hopper 310 that receives the metal power and have the inert gas directed into it (e.g., by a pump). This hopper 310 is designed to be tapered like a funnel to direct the metal powder and gas into a feed conduit 312. This feed conduit 312 is capable of being connected with the barrel 102 to direct the powder and gas into the barrel 102. For example, instead of having separate conduits that separately feed the metal powder and the inert gas into the barrel 102, the feed system 308 may deliver both the metal powder and the inert gas via the same conduit 312. The inductive heaters 106 are capable of being disposed around the barrel 102 and/or the conduit 312 as shown. This allows the inductive heaters 106 to heat the powder as the powder is delivered into the barrel 102. As described above, the actuator 116 is designed to rapidly move the needle 104 upward and down during the sintering process.

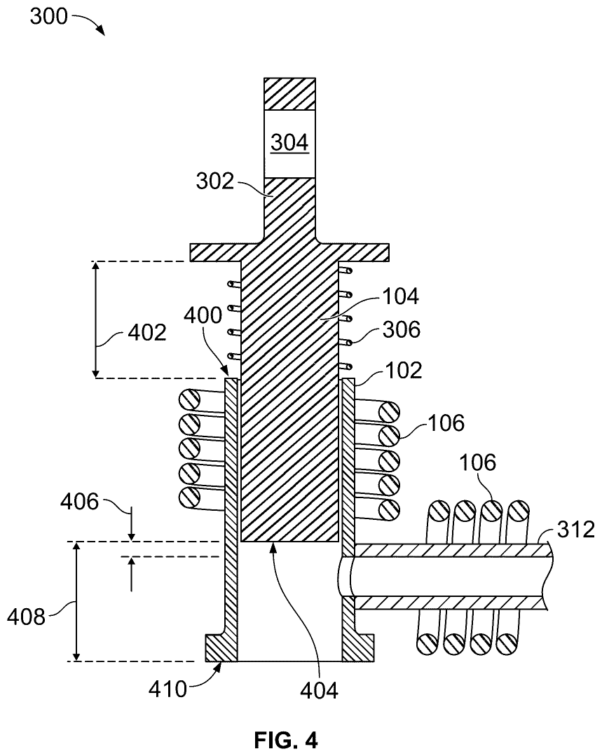

FIG. 4 illustrates a cross-sectional view of the microforge system 300 shown in FIG. 3. As shown, the hammer or piston 302 may be spaced apart from a top end 400 of the barrel 102 by a travel distance 402 while the biasing element 304 is not biased (e.g., not forced downward by the actuator 116). The actuator 116 is capable of pushing the hammer or piston 302 downward to compress the biasing element 304 and also push the needle 104 downward toward the build surface. The actuator 116 may be limited to pushing the hammer or piston 302 only as far as the travel distance 402 until the hammer or piston 302 contacts (and is prevented from further movement by) the top end 400 of the barrel 102.

A bottom end 404 of the needle 104 may be the end that contacts the metal powder to sinter the metal powder, as described herein. The bottom end 404 of the needle 104 may be spaced apart from or above the conduit 312 to provide a gap 406 through which the metal powder continues to flow into the inside of the barrel 102 when the hammer 302 and needle 104 is raised by the biasing element 304. For example, this gap may be provided while the actuator 116 is not forcing the hammer 302 and needle 104 down and the biasing element 304 is pushing or forcing the hammer 302 and needle 104 upward.

During sintering, the actuator 116 is designed to push the hammer 302 downward with sufficient force to overcome the opposing force provided by the biasing element 304. This moves the hammer 302 and the needle 104 down by the travel distance 402 until the hammer 302 contacts the top end 400 of the barrel 102. This sinters the metal powder, as described above.

A distance 408 between the bottom end 404 of the needle 104 and a bottom end or outlet 410 of the barrel 102 may be longer than the travel distance 402 to allow the metal powder to be sintered into additional laid down material 132. For example, the distance 408 is equal to the gap 406 and the travel distance 402, or at least as long as the gap 406 plus the travel distance 402.

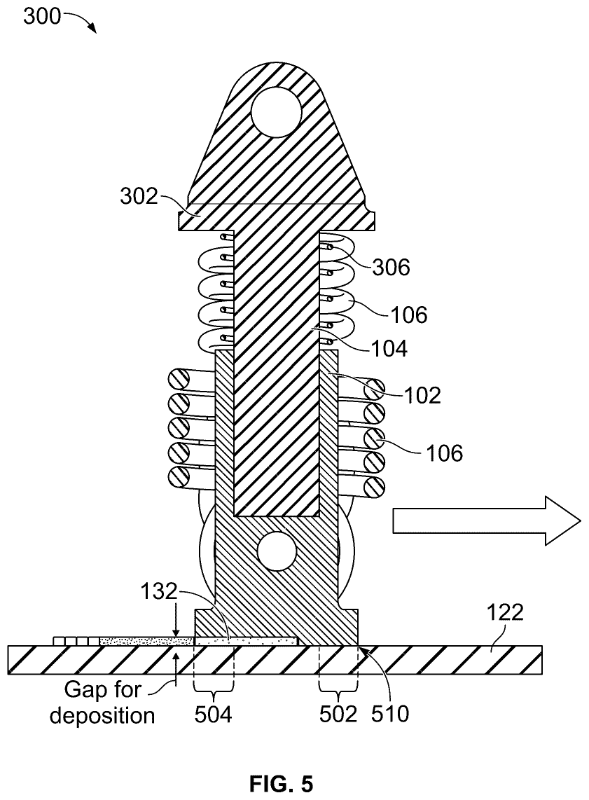

FIG. 5 illustrates a cross-sectional view of another example of the microforge system 300 shown in FIG. 3. As shown, a bottom end 510 of the barrel 102 may be a non-planar surface, while the bottom end 410 of the barrel 102 in FIG. 4 is a planar surface. The non-planar bottom end 510 may have a leading surface portion 502 and a trailing surface portion 504. These surface portions 502, 504 may each be planar or predominantly planar, but lie in different planes. For example, the trailing surface portion 504 may be higher or farther from the working surface than the leading surface portion 502. This is designed to provide space or room for the recently laid down material 132. For example, the recently laid down material 132 fills the gap between the trailing surface portion 504 and the build surface 122 as the microforge system 300 moves in the direction shown in FIG. 5.

“Substantially” is a term used in patent language to indicate that a particular feature or characteristic is largely, but not necessarily entirely, present or achieved. It allows for some degree of variation or deviation from the exact specification, acknowledging that minor differences or imperfections may exist without departing from the overall scope or intent of the subject matter described herein.

Further, the disclosure comprises examples according to the following clauses:

Clause 1: A microforge system comprising: a forge barrel including a forge head configured to move in opposite directions within the forge barrel; a metal supply device fluidly coupled with the forge barrel and configured to supply metal powder into the forge barrel; and one or more inductive heaters configured to inductively heat the metal powder within the forge barrel, the forge head configured to oscillate in the opposite directions within the forge barrel while the metal powder is heated and sintered by the forge head onto a substrate to form a solid metal additive layer on the substrate.

Clause 2: The microforge system of clause 1, further comprising: an inert gas supply device fluidly coupled with the forge barrel and configured to load inert gas into the forge barrel.

Clause 3: The microforge system of clause 2, wherein the inert gas supply device is configured to load the inert gas into the forge barrel for the metal powder to be heated and forged without a vacuum chamber.

Clause 4: The microforge system of clause 1, wherein the forge head is configured to compact the metal powder while heated by the one or more inductive heaters to produce the solid metal additive layer with a wrought microstructure on the substrate.

Clause 5: The microforge system of clause 1, further comprising: a translation system coupled with the forge barrel and the one or more inductive heaters, the translation system configured to move the forge barrel and the one or more inductive heaters in one or more movement directions transversely oriented relative to the opposite directions in which the forge head oscillates.

Clause 6: The microforge system of clause 1, further comprising: a force applicator configured to apply a downward force onto the solid metal additive layer and change a grain structure of the solid metal additive layer.

Clause 7: The microforge system of clause 6, wherein the force applicator includes an isostatic bearing roller configured to roll on top of the solid metal additive layer to apply the downward force.

Clause 8: A method comprising: supplying metal powder into a forge barrel of a microforge system; inductively heating the metal powder within the forge barrel; and oscillating a forge head in opposite directions within the forge barrel while the metal powder is heated to sinter the forge head onto a substrate and form a solid metal additive layer on the substrate.

Clause 9: The method of clause 8, further comprising: loading inert gas into the forge barrel ahead of the metal powder.

Clause 10: The method of clause 8, wherein oscillating the forge head and inductively heating the metal powder compacts the metal powder to produce the solid metal additive layer with a wrought microstructure on the substrate.

Clause 11: The method of clause 8, further comprising: moving the forge barrel in one or more movement directions transversely oriented relative to the opposite directions in which the forge head oscillates while the solid metal additive layer is formed on the substrate.

Clause 12: The method of clause 8, further comprising: changing a grain structure of the solid metal additive layer by applying a downward force onto the solid metal additive layer.

Clause 13: The method of clause 12, wherein the downward force is applied by rolling an isostatic bearing roller on top of the solid metal additive layer.

Clause 14: A microforge system comprising: a forge barrel including a forge head configured to move in opposite directions within the forge barrel; a metal supply device fluidly coupled with the forge barrel and configured to supply metal into the forge barrel; and one or more inductive heaters configured to inductively heat the metal within the forge barrel, the forge head configured to oscillate in the opposite directions within the forge barrel to heat and sinter the metal onto a substrate to form a solid metal additive layer on the substrate while the forge barrel and the one or more inductive heaters move relative to the substrate.

Clause 15: The microforge system of clause 14, further comprising: an inert gas supply device fluidly coupled with the forge barrel and configured to load inert gas into the forge barrel ahead of the metal.

Clause 16: The microforge system of clause 15, wherein the inert gas supply device is configured to load the inert gas into the forge barrel for the metal to be heated and forged without a vacuum chamber.

Clause 17: The microforge system of clause 14, wherein the forge head is configured to compact the metal while heated by the one or more inductive heaters to produce the solid metal additive layer with a wrought microstructure on the substrate.

Clause 18: The microforge system of clause 14, further comprising: a translation system coupled with the forge barrel and the one or more inductive heaters, the translation system configured to move the forge barrel and the one or more inductive heaters in one or more movement directions transversely oriented relative to the opposite directions in which the forge head oscillates.

Clause 19: The microforge system of clause 14, further comprising: a force applicator configured to apply a downward force onto the solid metal additive layer and change a grain structure of the solid metal additive layer.

Clause 20: The microforge system of clause 19, wherein the force applicator includes an isostatic bearing roller configured to roll on top of the solid metal additive layer to apply the downward force.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A microforge system comprising:
a forge barrel including a forge head configured to move in opposite directions within the forge barrel;
a metal supply device fluidly coupled with the forge barrel and configured to supply metal powder into the forge barrel; and
one or more inductive heaters configured to inductively heat the metal powder within the forge barrel, the forge head configured to oscillate in the opposite directions within the forge barrel while the metal powder is heated and sintered by the forge head onto a substrate to form a solid metal additive layer on the substrate.

2. The microforge system of claim 1, further comprising:
an inert gas supply device fluidly coupled with the forge barrel and configured to load inert gas into the forge barrel.

3. The microforge system of claim 2, wherein the inert gas supply device is configured to load the inert gas into the forge barrel for the metal powder to be heated and forged without a vacuum chamber.

4. The microforge system of claim 1, wherein the forge head is configured to compact the metal powder while heated by the one or more inductive heaters to produce the solid metal additive layer with a wrought microstructure on the substrate.

5. The microforge system of claim 1, further comprising:
a translation system coupled with the forge barrel and the one or more inductive heaters, the translation system configured to move the forge barrel and the one or more inductive heaters in one or more movement directions transversely oriented relative to the opposite directions in which the forge head oscillates.

6. The microforge system of claim 1, further comprising:
a force applicator configured to apply a downward force onto the solid metal additive layer and change a grain structure of the solid metal additive layer.

7. The microforge system of claim 6, wherein the force applicator includes an isostatic bearing roller configured to roll on top of the solid metal additive layer to apply the downward force.

8. A method for sintering a metal powder into a solid metal additive layer, the method comprising:
supplying the metal powder into a forge barrel of a microforge system;
inductively heating the metal powder within the forge barrel; and
oscillating a forge head in opposite directions within the forge barrel while the metal powder is heated to sinter the forge head onto a substrate and form the solid metal additive layer on the substrate.

9. The method of claim 8, further comprising:
loading inert gas into the forge barrel ahead of the metal powder.

10. The method of claim 8, wherein oscillating the forge head and inductively heating the metal powder compacts the metal powder to produce the solid metal additive layer with a wrought microstructure on the substrate.

11. The method of claim 8, further comprising:
moving the forge barrel in one or more movement directions transversely oriented relative to the opposite directions in which the forge head oscillates while the solid metal additive layer is formed on the substrate.

12. The method of claim 8, further comprising:
changing a grain structure of the solid metal additive layer by applying a downward force onto the solid metal additive layer.

13. The method of claim 12, wherein the downward force is applied by rolling an isostatic bearing roller on top of the solid metal additive layer.

14. A microforge system comprising:
a forge barrel including a forge head configured to move in opposite directions within the forge barrel;
a metal supply device fluidly coupled with the forge barrel and configured to supply metal into the forge barrel; and
one or more inductive heaters configured to inductively heat the metal within the forge barrel, the forge head configured to oscillate in the opposite directions within the forge barrel to heat and sinter the metal onto a substrate to form a solid metal additive layer on the substrate while the forge barrel and the one or more inductive heaters move relative to the substrate.

15. The microforge system of claim 14, further comprising:
an inert gas supply device fluidly coupled with the forge barrel and configured to load inert gas into the forge barrel ahead of the metal.

16. The microforge system of claim 15, wherein the inert gas supply device is configured to load the inert gas into the forge barrel for the metal to be heated and forged without a vacuum chamber.

17. The microforge system of claim 14, wherein the forge head is configured to compact the metal while heated by the one or more inductive heaters to produce the solid metal additive layer with a wrought microstructure on the substrate.

18. The microforge system of claim 14, further comprising:
a translation system coupled with the forge barrel and the one or more inductive heaters, the translation system configured to move the forge barrel and the one or more inductive heaters in one or more movement directions transversely oriented relative to the opposite directions in which the forge head oscillates.

19. The microforge system of claim 14, further comprising:
a force applicator configured to apply a downward force onto the solid metal additive layer and change a grain structure of the solid metal additive layer.

20. The microforge system of claim 19, wherein the force applicator includes an isostatic bearing roller configured to roll on top of the solid metal additive layer to apply the downward force.
